(19) United States
(12) Patent Application Publication
(10) Pub. No.: US 2025/0367637 A1
(43) Pub. Date: Dec. 4, 2025

(54) METAL ORGANIC FRAMEWORK AND METHOD OF PRODUCING THE SAME

(71) Applicant: TOYOTA JIDOSHA KABUSHIKI KAISHA, Toyota-shi (JP)

(72) Inventor: Yoshio OHASHI, Gotemba-shi (JP)

(73) Assignee: TOYOTA JIDOSHA KABUSHIKI KAISHA, Toyota-shi (JP)

(21) Appl. No.: 19/027,915

(22) Filed: Jan. 17, 2025

(30) Foreign Application Priority Data
May 29, 2024 (JP) 2024-086802

(51) Int. Cl. B01J 20/22; B01D 53/02; B01J 20/30; C07F 3/06

(52) U.S. Cl. CPC B01J 20/226; B01D 53/02; B01J 20/3078; B01J 20/3085; C07F 3/06; B01D 2253/204; B01D 2257/102

(57) ABSTRACT

One aspect of the present disclosure relates to a metal organic framework having a topology of RHO type comprising zinc (Zn) as a metal and benzimidazole (BzIm) and 4-methylimidazole (4-MeIm) as ligands. Another aspect of the present disclosure relates to a method of manufacturing a metal organic framework having the above-described features.

### CROSS-REFERENCE TO RELATED APPLICATION

This application claims priority to Japanese Patent Application No. 2024-086802 filed on May 29, 2024, incorporated herein by reference in its entirety.

### BACKGROUND

### 1. Technical Field

The present disclosure relates to a metal organic framework and a method of producing the same.

### 2. Description of Related Art

A metal organic framework (hereinafter referred to as an “MOF”) is a crystalline porous material composed of metal and organic ligands. Properties such as pore size and topography of the MOF can be designed at the molecular level according to the combination of the metal and the organic ligands used. The MOF is expected to be applied to gas storage materials, heterogeneous catalysis, and conductive materials, for example.

For example, K. S. Park et al., “Exceptional chemical and thermal stability of zeolitic imidazolate frameworks”, PNAS, vol. 103, no. 27, p. 10186-10191 (2006) discloses solvothermal synthesis of RHO-type Zn(BzIm)₂ (ZIF-11). Here, BzIm represents benzimidazole.

I. Brekalo et al., “Exploring the Scope of Macrocyclic “Shoe-last” Templates in the Mechanochemical Synthesis of RHO Topology Zeolitic Imidazolate Frameworks (ZIFs)”, molecules, 25, 633 (2020) discloses mechanochemical synthesis of RHO-type Zn(BzIm)₂ (ZIF-11) in which rccc-MeMeCH₂ is used as a template.

P. Zhao et al., “Phase Transitions in Zeolitic Imidazolate Framework 7: The Importance of Framework Flexibility and Guest-Induced Instability”, Chem. Mater., 26, p. 1767-1769 (2014) discloses production of layered Zn(BzIm)₂ (ZIF-7-III), which is a dense phase stable at high temperatures.

### SUMMARY

Zn(BzIm)₂ may take topologies of RHO (FIG. 1), layered (FIG. 2 and P. Zhao et al., “Phase Transitions in Zeolitic Imidazolate Framework 7: The Importance of Framework Flexibility and Guest-Induced Instability”, Chem. Mater., 26, p. 1767-1769 (2014)), and SOD types. Among these, it has been found that the RHO type has the largest pore volume and an excellent gas adsorption quantity.

In K. S. Park et al., “Exceptional chemical and thermal stability of zeolitic imidazolate frameworks”, PNAS, vol. 103, no. 27, p. 10186-10191 (2006), single-phase Zn(BzIm)₂ of RHO type has been obtained through liquid phase synthesis. In the liquid phase synthesis, Zn becomes zinc ions (Zn²⁺) and is easily reacted since it has been completely dissolved. In addition, since unreacted Zn²⁺ remains dissolved in the solution, ZnO and the like are unlikely to be mixed as impurities. On the other hand, the concentration of Zn²⁺ is only equivalent to 6.4 mmol/L, and it is necessary to use as much as 156 L of DEF as the solvent per 1 mol of Zn. As a consequence, the yield of Zn(BzIm)₂ of RHO type relative to the solvent and the raw materials is only 0.1 wt % or less.

In I. Brekalo et al., “Exploring the Scope of Macrocyclic “Shoe-last” Templates in the Mechanochemical Synthesis of RHO Topology Zeolitic Imidazolate Frameworks (ZIFs)”, molecules, 25, 633 (2020), Zn(BzIm)₂ of RHO type has been obtained through mechanochemical synthesis in which rccc-MeMeCH₂ is used as a template. On the other hand, since rccc-MeMeCH₂ is not commercially available, a synthesized one is used. When such a template is used, the production cost increases.

In addition, in Zn(BzIm)₂ of RHO type, the pore windows are small, and there is room for improving the gas adsorption/desorption rate.

Thus, it is an object of the present disclosure to provide an MOF having RHO topology having a high gas absorption/desorption property, and a method of producing the MOF in a high yield.

The present inventor has studied various means for addressing the above issue. In the production of an MOF, the present inventor conducted mechanochemical synthesis with a part of BzIm in the zinc compound and the benzimidazole (BzIm) as the raw materials replaced with 4-methylimidazole (4-MeIm). As illustrated in FIG. 3, 4-MeIm (B) having a steric hindrance smaller than that of BzIm (A) has high solubility and diffusibility, and is easily reacted. Further, when a part of BzIm of Zn(BzIm)₂ of RHO type is replaced with 4-MeIm having a small steric hindrance and becomes RHO Zn(BzIm)_{2-z}(4-MeIm)_{z}, the pore windows are enlarged as illustrated in FIG. 4, and the diffusibility of the raw material and the gases in the product is improved. The present inventor has completed the present disclosure based on the above findings.

Thus, the present disclosure encompasses the following aspects.

### Aspect 1

A metal organic framework having RHO topology, including
zinc (Zn) as metal and benzimidazole (BzIm) and 4-methylimidazole (4-MeIm) as ligands.

### Aspect 2

The metal organic framework according to aspect 1, in which
a molar ratio (4-MeIm/(BzIm+4-MeIm)) of 4-MeIm to a total of BzIm and 4-MeIm is in a range of 0.11 to 0.53.

### Aspect 3

A gas absorbing and desorbing material including an absorbing and desorbing material, in which:
the absorbing and desorbing material contains the metal organic framework according to aspect 1 or 2; and
the metal organic framework contains the RHO topology in an amount of 90 mol % or more based on a total substance amount of the metal organic framework.

### Aspect 4

A method of producing the metal organic framework according to aspect 1 or 2, including:
a mechanochemical reaction step of subjecting a zinc compound, BzIm, and 4-MeIm to a mechanochemical reaction in presence of a solvent; and
a heating step after the mechanochemical reaction step, in which
a relationship between a charge amount of 4-MeIm and a heating temperature is adjusted to be within the range of a quadrilateral having (x, y)=(12.5, 80), (50, 80), (50, 130), and (12.5, 100) as vertices in an x-y graph indicating the relationship between the charge amount of 4-MeIm (x mol %) and the heating temperature (y ° C.).

### Aspect 5

The method according to aspect 4, in which
the solvent is N,N-diethylformamide (DEF).

### Aspect 6

The method according to aspect 4 or 5, in which
the zinc compound is zinc oxide (ZnO).

According to the present disclosure, it is possible to provide an MOF having RHO topology having a high gas absorption/desorption property, and a method of producing MOF in a high yield.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing the configuration of an RHO type Zn(BzIm)₂;

FIG. 2 is a schematic diagram of a layered Zn(BzIm)₂;

FIG. 3 is a diagram schematically showing the configurations of BzIm (A) and 4-MeIm (B);

FIG. 4 is a schematic diagram of an RHO type Zn(BzIm)_{2-z}(4-MeIm)_{z};

FIG. 5 is a graph showing the X-ray diffraction pattern of the powder of the products of Comparative Examples 1-1, 1-5 and 1-6 and Examples 1-2 to 1-4; the horizontal axis represents the 2θ value (°), and the vertical axis represents the strength (a.u.); the x represents 4-MeIm charge (material amount) (mol %) (hereinafter referred to as “4-MeIm charge amount (mol %)”) with respect to the material amount of the entire ligand (BzIm and 4-MeIm); and RHO type, the layered type, and ACO type show the simulation result of the X-ray diffraction pattern by calculation of the Zn(BzIm)₂ of RHO type, layered Zn(BzIm)₂, and Zn(BzIm)₂ of ACO type, respectively;

FIG. 6 is a graph showing the X-ray diffraction pattern of the products of Comparative Examples 2-1, 2-5, and 2-6 and Examples 2-2 to 2-4; the horizontal axis represents the 2θ value (°) and the vertical axis represents the strength (a.u.); the x represents the charge amount (mol %) of 4-MeIm; and RHO type, the layered type, and ACO type show the simulation result of the X-ray diffraction pattern by calculation of the Zn(BzIm)₂ of RHO type, layered Zn(BzIm)₂, and Zn(BzIm)₂ of ACO type, respectively;

FIG. 7 is a graph showing the X-ray diffraction pattern of the products of Comparative Examples 3-1 to 3-3, 3-5 and 3-6 and Example 3-4; the horizontal axis represents the 2θ value (°) and the vertical axis represents the strength (a.u.); the x represents the charge amount (mol %) of 4-MeIm; and RHO type, the layered type, and ACO type show the simulation result of the X-ray diffraction pattern by calculation of the Zn(BzIm)₂ of RHO type, layered Zn(BzIm)₂, and Zn(BzIm)₂ of ACO type, respectively;

FIG. 8 is a graph showing the crystalline structure of the product produced in relation to the charge of 4-MeIm (mol %) (horizontal axis) and the heated temperature (° C.) (vertical axis); O represents RHO type, x represents layered, and Δ represents ACO type;

FIG. 9 is a graph showing N₂ adsorption-desorption isotherms of the products of Comparative Examples 1-5 and 1-6 and Examples 1-2 to 1-4; the horizontal axis represents N₂ relative pressure (%) and the vertical axis represents N₂ adsorption amount (mL(STP)·g⁻¹); x represents 4-MeIm charge amount (mol %);

FIG. 10 is a graph showing N₂ adsorption-desorption isotherms of the products of Comparative Examples 2-5 and 2-6 and Examples 2-2 to 2-4; the horizontal axis represents N₂ relative pressure (%) and the vertical axis represents N₂ adsorption amount (mL(STP)·g⁻¹); x represents 4-MeIm charge amount (mol %);

FIG. 11 is a graph showing the N₂ adsorption-desorption isotherm of the products of Comparative Examples 3-1 to 3-3, 3-5 and 3-6 and Example 3-4; the horizontal axis represents the N₂ relative pressure (%) and the vertical axis represents the N₂ adsorption amount (mL(STP)·g⁻¹); x represents 4-MeIm charge amount (mol %); and

FIG. 12 is a graph showing the crystal structure of the product produced at each heating temperature in relation to the charge amount (mol %) (horizontal axis) of 4-MeIm and the adsorption amount of N₂ (mL(STP)/g⁻¹) when the N₂ relative pressure is 50% (vertical axis). O represents an RHO type, X represents a layer type, and A represents a ACO type.

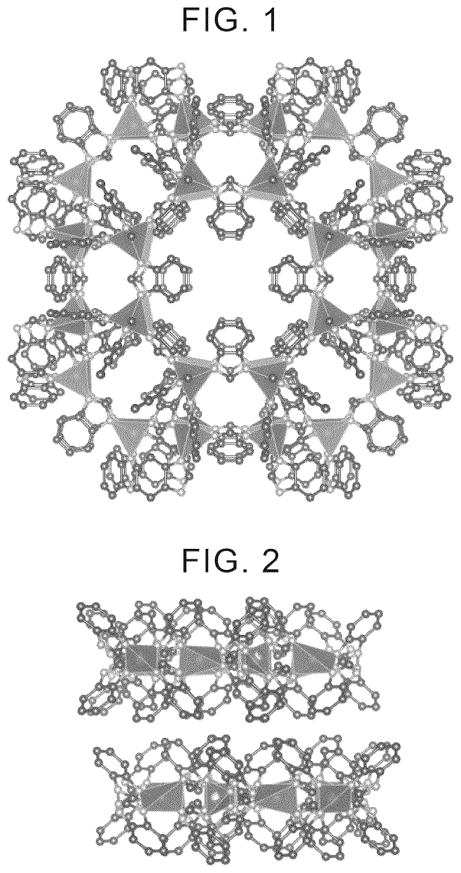

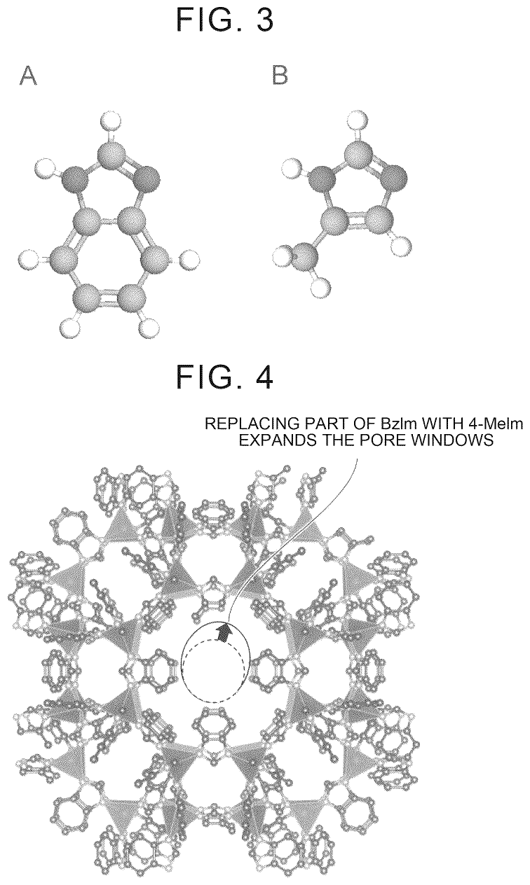

### DETAILED DESCRIPTION OF EMBODIMENTS

Hereinafter, preferred embodiments of the present disclosure will be described in detail.

### 1: Metal Organic Framework

One aspect of the present disclosure relates to a metal organic framework (MOF). An MOF of this embodiment is a metal organic framework having a topology of RHO type comprising zinc (Zn) as a metal and benzimidazole (BzIm) and 4-methylimidazole (4-MeIm) as ligands.

Zn and BzIm containing Zn(BzIm)₂ of MOF may take various topologies such as RHO type (ZIF-11), layered (ZIF-7-III), and SOD type. Among them, ZIF-11 has a large gas-adsorption capacity. However, ZIF-11 is difficult to obtain in high-purity because it is produced in competition with ZIF-7-III having no pores. In addition, since the pore windows of ZIF-11 are narrow, gases such as nitrogen (N₂) diffuse slowly.

In ZIF-11, when Zn(BzIm)_{2-z}(4-MeIm)_{z} is synthesized by adding 4-MeIm to BzIm as a ligand, RHO type is easily obtained by destabilizing the layered crystalline structure. In addition, a portion of BzIm is replaced with 4-MeIm to enlarge the pore windows. As a result, the gas adsorption amount can be further increased, and the gas diffusibility can also be improved.

In ZIF-11, ZIF-7-III that can be generated in competition interact with each other by BzIm benzene-rings in the structure facing each other. However, the interaction is lost by replacing a portion of BzIm with 4-MeIm. As a consequence, replacement with 4-MeIm destabilizes the layered structure. This makes it easier for RHO types to be formed.

In MOF of this embodiment, the molar ratio of 4-MeIm to the sum of BzIm and 4-MeIm (4-MeIm/(BzIm+4-MeIm)) in the ligand is not limited as long as MOF of this embodiment can have a RHO type. (4-MeIm/(BzIm+4-MeIm)) is typically in the range of 0.11 to 0.53, and in one embodiment in the range of 0.25 to 0.50. When the molar ratio of BzIm to 4-MeIm in the ligand is within the above-described range, MOF of the present embodiment can have an RHO topology and can have a higher gas-adsorption/desorption property.

MOF of this embodiment generally comprises the following formulae (I): Zn(BzIm)₂-z (4-MeIm)_{z}

It is expressed by. In formulae (I), BzIm is benzimidazole as the ligand and 4-MeIm is 4-methylimidazole as the ligand. From the formulae (I), the molar ratio (Zn:(BzIm+4-MeIm)) of the metallic Zn to the sum of the ligand BzIm and 4-MeIm is 1:2. In Formulae (I), z is not limited as long as it is greater than 0 and less than 2, based on the molar fraction of 4-MeIm to the sum of BzIm and 4-MeIm in the ligands described above. z is typically in the range of 0.22 to 1.06, and in one embodiment in the range of 0.50 to 1.00. MOF of this aspect represented by the formulae (I) can have a high-gas-absorption/desorption property.

The gas-adsorption/desorption property of MOF of the present embodiment can be evaluated, for example, by measuring the N₂ adsorption isotherm of MOF. The gas-adsorption property of MOF of the present embodiment can be evaluated, for example, by calculating an amount of adsorption of N₂ at a relative pressure of 50% of N₂. The N₂ adsorption at 50% of the N₂ relative pressure in MOF of this embodiment is typically greater than or equal to 180 mL(STP)·g⁻¹, in one embodiment 180 mL(STP)·g⁻¹ to 320 mL(STP)·g⁻¹.

### 2: Method for Producing Metal Organic Framework

Another aspect of the present disclosure relates to a method for producing a metal organic framework according to one aspect of the present disclosure.

The method of this embodiment comprises a mechanochemical reaction step. The process comprises mechanochemically reacting a zinc compound with benzimidazole (BzIm) and 4-methylimidazole (4-MeIm) in the presence of solvents. In the present specification, the mechanochemical reaction means that a chemical reaction proceeds by changing a crystal structure of a raw material by applying a mechanical stress such as grinding to a raw material, usually a raw material containing a solid. Therefore, in the mechanochemical reaction of the present disclosure, a chemical reaction is caused to proceed by applying a mechanical stress by stirring, mixing, or the like to those in which a zinc compound that is not dissolved in a solvent as a raw material is present.

The zinc compound used in this step is, but not limited to, for example, zinc oxide (ZnO), zinc hydroxide (Zn(OH)₂), or mixtures thereof, and in one embodiment, zinc oxide. The reactivity of the zinc compound exemplified above can be improved by using a solvent exemplified below. Therefore, by carrying out the present step using the zinc compound exemplified above, the mechanochemical reaction can be efficiently carried out to obtain MOF of one embodiment of the present disclosure.

The amount of benzimidazole (BzIm) and 4-methylimidazole (4-MeIm) charged is usually twice the amount of zinc material. Also, the charge of 4-MeIm is adjusted so that the molar ratio of 4-MeIm to the sum of BzIm and 4-MeIm (4-MeIm/(BzIm+4-MeIm)) is in the range of 0.125 to 0.500, in one embodiment in the range of 0.250 to 0.500. By adjusting the charge of 4-MeIm to the above range, Zn(BzIm)_{2-z}(4-MeIm)_{z} has an RHO topology in the heating-temperature range described below.

The content (molar ratio) of 4-MeIm in MOF of one embodiment of the present disclosure and the charge amount (molar ratio) of 4-MeIm in the production process of MOF of another embodiment of the present disclosure generally have the same degree of relation within an error of about 10%. This is because the inventive synthetic process has a high reactivity of BzIm and 4-MeIm, both of which are incorporated almost entirely into MOF when contacted with ZnO, MOF produced once is stable, and BzIm and 4-MeIm are not eluted, so that a MOF containing BzIm and 4-MeIm in approximately the same ratio as the charge can be obtained.

The solvents used in this step are liquid compounds which can dissolve BzIm and 4-MeIm as the ligand as a raw material and serve as a reaction site for Zn, and BzIm and 4-MeIm in the mechanochemical reaction. Solvents include, but are not limited to, cyclohexane, N,N-dimethylformamide (DMF), N,N-diethylformamide (DEF), methanol, ethanol, or a mixture of two or more thereof. In one embodiment, the solvents are DEF. The solvents exemplified above may dissolve the raw materials BzIm and 4-MeIm. Therefore, by carrying out this step using the solvents exemplified above, the mechanochemical reaction can be efficiently carried out to obtain MOF of one embodiment of the present disclosure.

The amount of solvent in this step is not limited, but is usually from 20 wt % to 60 wt %, and in one embodiment from 30 wt % to 50 wt %, based on the total weight of the feedstock. When the amount of the solvent in this step falls within the above range, MOF of one embodiment of the present disclosure can be obtained without using a large amount of the solvent, and thus the production efficiency is improved.

In this step, the mechanochemical reaction can be carried out by mixing the raw materials using a mortar. The mixing time in the mortar is typically 20 minutes or more, in one embodiment in the range of 20 minutes to 3 hours, for example in the range of 30 minutes to 2 hours. Furthermore, the mixing temperature in the mortar is typically in the range of 0° C. to 50° C., in one embodiment in the range of 10° C. to 30° C. By carrying out this step in the above-described conditions, it is possible to efficiently proceed the mechanochemical reaction to obtain MOF of one aspect of the present disclosure.

In this step, the mechanochemical reaction may be performed by mixing the raw materials using a ball mill. In the present embodiment, the rotational speed of the ball mill is not limited, but is usually 50 rpm or higher, and in one embodiment, the rotational speed is 800 rpm from 50 rpm. In addition, the mixing time by the ball mill is usually 1 hour or more, and in one embodiment, the mixing time is in the range of 1 hour to 3 hours. Furthermore, the mixing temperature by the ball mill is usually in the range of 0° C. to 100° C., in one embodiment in the range of 10° C. to 50° C. By carrying out this step in the above-described conditions, it is possible to efficiently proceed the mechanochemical reaction to obtain MOF of one aspect of the present disclosure.

The mechanochemically reacted raw material is subsequently subjected to a heating step. In this heating step, the relationship between the charge amount and the heating temperature of 4-MeIm, in x-y plot showing the relationship between the charge amount of 4-MeIm (x mol %) and the heating temperature (y ° C.), (x, y)=(12.5, 80), (50, 80), (50, 130) and (12.5, 100) is adjusted to be within a square having a vertex. That is, the heating temperature may vary depending on the charge amount of 4-MeIm. By adjusting the heating-temperature to the extent according to the charge of 4-MeIm, Zn(BzIm)_{2-z}(4-MeIm)_{z} has an RHO topology.

As described above, MOF of one embodiment of the present disclosure has a RHO type topology in which a part of BzIm as a ligand is substituted by 4-MeIm, and thus can have a large pore volume and a high gas-adsorption/desorption property. MOF of one aspect of the present disclosure further allows for high-speed, high-gas absorption and desorption by enlarging the pore windows. Therefore, MOF of one aspect of the present disclosure can be used as a gas absorbing and desorbing material, and the gas absorbing and desorbing material can be applied to a gas adsorption/desorption system, a gas separation system, or a gas storage system. The gas absorbing and desorbing material of one aspect of the present disclosure comprises MOF of one aspect of the present disclosure, wherein MOF comprises a RHO topology in an 90 mol % or more, in one embodiment 95 mol % or more, and in one embodiment 99 mol % or more, based on the total amount of MOF. In one embodiment, a gas absorbing and desorbing material comprising a MOF of one aspect of the present disclosure comprises a MOF of one aspect of the present disclosure, wherein MOF comprises an RHO topology in a single phase. By single phase here is meant that all of MOF of one aspect of the present disclosure exist in an RHO topology. In addition, in the production process of one embodiment of the present disclosure, MOF of one embodiment of the disclosure having the characteristics described above can be obtained in high yield. Therefore, the manufacturing method of one embodiment of the present disclosure can efficiently provide a material applicable to the applications exemplified above.

Hereinafter, the present disclosure will be described in more detail with reference to Examples. However, the technical scope of the present disclosure is not limited to these examples.

### I: Production of Metal Organic Frameworks

### Reagents

Zinc oxide (ZnO): Fujifilm Wako Pure Chemical Co., Ltd. 0.02 μm Practical grade 95.0+%
Benzimidazole (BzIm): Tokyo Chemical Industry Co., Ltd. >98.0%
4-methylimidazole (4-MeIm): Tokyo Chemical Industry Co., Ltd. >98.0%
Ethanol (EtOH): Special class 94.8% to 95.8% of Kanto Chemical Co., Ltd.
N,N-diethylformamide (DEF): Tokyo Chemical Industry Co., Ltd. >98.0%

### Comparative Example 1-1

(1) ZnO (12.2 g, 150 mmol), BzIm (35.4 g, 300 mmol), and DEF (30 mL) were added to the agate mortar.
(2) The mixture was mixed in an agate mortar for 30 minutes and the mixture was transferred to a PTFE vessel of 100 mL.
(3) PTFE container was placed in a pressure-resistant stainless-steel outer tube and heated at 80° C. for 48 hours.
(4) EtOH (50 mL) was added to the content, stirred, centrifuged at 16,000 rpm for 15 minutes, and the supernatant was removed.
(5) (4) was repeated a total of four times.
(6) The recovered precipitate was dried at 60° C. overnight under reduced pressure to give a powder.

### Example 1-2

A powder was obtained in the same manner as in Comparative Example 1-1 except that BzIm (35.4 g, 300 mmol) was changed to BzIm (31.0 g, 262.5 mmol) and 4-MeIm (3.08 g, 37.5 mmol) in Comparative Example 1-1.

### Example 1-3

A powder was obtained in the same manner as in Comparative Example 1-1 except that BzIm (35.4 g, 300 mmol) was changed to BzIm (26.6 g, 225 mmol) and 4-MeIm (6.16 g, 75 mmol) in Comparative Example 1-1.

### Examples 1-4

A powder was obtained in the same manner as in Comparative Example 1-1 except that BzIm (35.4 g, 300 mmol) was changed to BzIm (17.7 g, 150 mmol) and 4-MeIm (12.3 g, 150 mmol) in Comparative Example 1-1.

### Comparative Example 1-5

A powder was obtained in the same manner as in Comparative Example 1-1 except that BzIm (35.4 g, 300 mmol) was changed to BzIm (8.86 g, 75 mmol) and 4-MeIm (18.5 g, 225 mmol) in Comparative Example 1-1.

### Comparative Example 1-6

In Comparative Example 1-1, a powder was obtained in the same manner as in Comparative Example 1-1 except that BzIm (35.4 g, 300 mmol) was changed to 4-MeIm (24.6 g, 300 mmol).

### Comparative Example 2-1

In Comparative Example 1-1, a powder was obtained in the same manner as in Comparative Example 1-1 except that the heating temperature was changed to 100° C.

### Example 2-2

In Example 1-2, a powder was obtained in the same manner as in Example 1-2, except that the heating temperature was changed to 100° C.

### Example 2-3

In Example 1-3, a powder was obtained in the same manner as in Example 1-3, except that the heating temperature was changed to 100° C.

### Example 2-4

In Example 1-4, a powder was obtained in the same manner as in Example 1-4, except that the heating temperature was changed to 100° C.

### Comparative Example 2-5

In Comparative Example 1-5, a powder was obtained in the same manner as in Comparative Example 1-5 except that the heating temperature was changed to 100° C.

### Comparative Example 2-6

In Comparative Example 1-6, a powder was obtained in the same manner as in Comparative Example 1-6, except that the heating temperature was changed to 100° C.

### Comparative Example 3-1

In Comparative Example 1-1, a powder was obtained in the same manner as in Comparative Example 1-1 except that the heating temperature was changed to 130° C.

### Comparative Example 3-2

In Example 1-2, a powder was obtained in the same manner as in Example 1-2, except that the heating temperature was changed to 130° C.

### Comparative Example 3-3

In Example 1-3, a powder was obtained in the same manner as in Example 1-3, except that the heating temperature was changed to 130° C.

### Example 3-4

In Example 1-4, a powder was obtained in the same manner as in Example 1-4, except that the heating temperature was changed to 130° C.

### Comparative Example 3-5

In Comparative Example 1-5, a powder was obtained in the same manner as in Comparative Example 1-5 except that the heating temperature was changed to 130° C.

### Comparative Example 3-6

In Comparative Example 1-6, a powder was obtained in the same manner as in Comparative Example 1-6, except that the heating temperature was changed to 130° C.

### II: Evaluation of Metal Organic Frameworks

### Analysis of the Products

### 1. X-Ray Diffractometry: Checking the Crystallographic Structure of the Product (MOF)

X-ray diffraction measurements were performed on the powders obtained in Comparative Examples and Examples, respectively. The measurement device and the measurement conditions are shown below.
Measuring device: RINTRAPIDII (Rigaku Co., Ltd.)·
Measuring conditions: Voltage 50 V, current 100 mA, collimator diameter φ0.3, sample angle ω5°

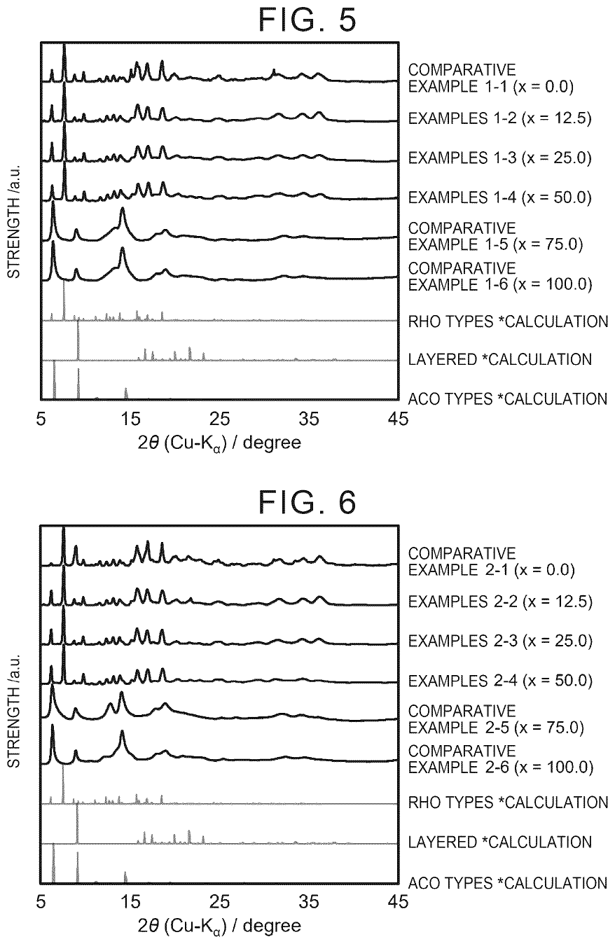

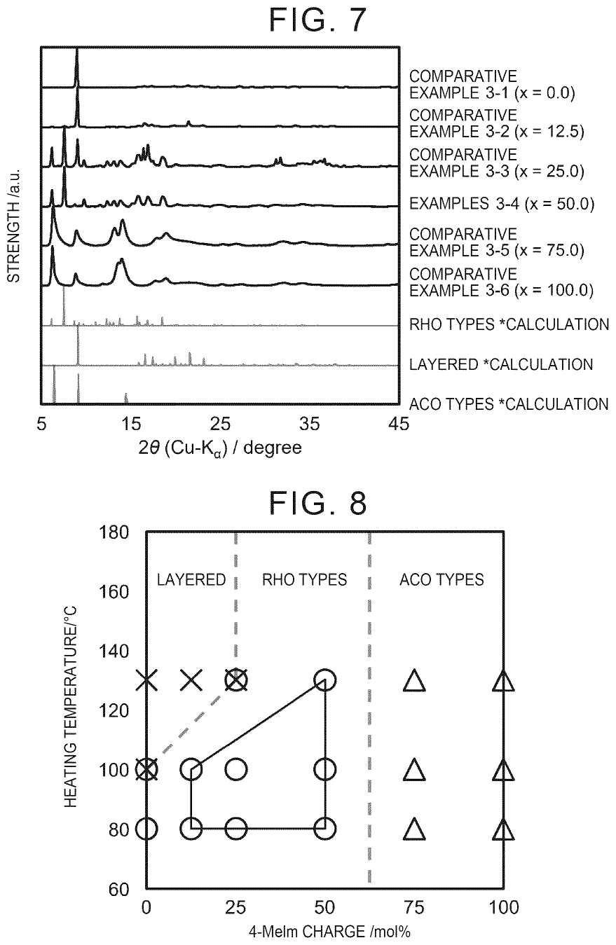

The X-ray diffractogram was simulated and compared with the product for RHO type Zn(BzIm)₂, layered Zn(BzIm)₂ and ACO type Zn(4-MeIm)₂. FIG. 5 shows X-ray diffractograms of the products of Comparative Examples 1-1, 1-5 and 1-6 and Examples 1-2 to 1-4, FIG. 6 shows X-ray diffractograms of the products of Comparative Examples 2-1, 2-5 and 2-6 and Examples 2-2 to 2-4, and FIG. 7 shows X-ray diffractograms of the products of Comparative Examples 3-1 to 3-3, 3-5 and 3-6 and Example 3-4.

FIG. 5 shows that RHO type product (Comparative Example 1-1 and Examples 1-2 to 1-4) is obtained when the charge of 4-MeIm is from 0 mol % to 50.0 mol % at 80° C. It was found that the product of ACO type (Comparative Examples 1-5 to 1-6) was obtained when the charge of 4-MeIm was 75.0 mol % or more.

As shown in FIG. 6, when the heating temperature is 100° C., a mixture of layered and RHO types (Comparative Example 2-1) is obtained when the charge amount of 4-MeIm is 0 mol %. When the charge of 4-MeIm is from 12.5 mol % to 50.0 mol %, the product in RHO form (Examples 2-2 to 2-4) is obtained. It was found that the product of ACO type (Comparative Examples 2-5 to 2-6) was obtained when the charge of 4-MeIm was 75.0 mol % or more.

As shown in FIG. 7, when the heating temperature is 130° C., a layered product (Comparative Examples 3-1 to 3-2) is obtained when the charge of 4-MeIm is from 0 mol % to 12.5 mol %. When the charge of 4-MeIm is 25 mol %, mixtures of layered and RHO types (Comparative Examples 3-3) are obtained. When the charge of 4-MeIm is 50 mol %, the product in RHO form (Examples 3-4) is obtained. It was found that the product of ACO type (Comparative Examples 3-5 to 3-6) was obtained when the charge of 4-MeIm was 75.0 mol % or more.

FIG. 8 shows the crystal-structure of the product produced in relation to the charge of 4-MeIm and the heating-temperature.

From FIG. 8, the following was found. When the charge of 4-MeIm was 0 mol %, a product of RHO type was obtained at a heating temperature of 80° C., a mixture of layered and RHO type was obtained at a heating temperature of 100° C., and a product of layered type was obtained at a heating temperature of 130° C. On the other hand, when a part of BzIm was replaced with 4-MeIm, the product of RHO type was obtained even when the heating temperature was 100° C. or 130° C., and therefore the temperature at which RHO type was formed was expanded to the high temperature. This is presumed to be because the layered Zn(BzIm)₂ interacts with BzIm benzene rings in the structure by facing each other, but the interaction is lost by replacing a part of BzIm with 4-MeIm, so that the replacement by 4-MeIm destabilizes the layered crystalline structure and the formation of RHO type is dominant. In addition, when the charge of 4-MeIm became 75 mol % or more, the product of ACO type was obtained. This is considered to be because if 4-MeIm is too large, RHO type is destabilized, and Zn (4-MeIm) the formation of ACO type, which is a stable crystalline structure of 2, is dominant. Therefore, in order to generate RHO type, in x-y chart showing the relation between the charge amount (x mol %) of 4-MeIm and the heating temperature (y ° C.), as shown in FIGS. 8, (x, y)=(12.5, 80), (50, 80), (50, 130), and (12.5, 100) It was found that it needs to be adjusted so as to be within a square having a vertex.

When the molar ratio of the layered product to RHO product ((RHO type/(layered+RHO type))×100) was determined from the peak intensities of the X-ray diffractograms of Comparative Example 2-1 and Comparative Example 3-3, the molar ratio was 71 mol % in Comparative Example 2-1 and 60 mol % in Comparative Example 3-3.

### 2. ¹H-NMR Determination: Compositional Analyses of MOF

The products of the Examples and Comparative Examples were decomposed and dissolved in a heavy solvent. 1H-NMR spectrum of the obtained solutions was measured, and the ratio of BzIm and 4-MeIm contained in MOF was determined from the integration ratio of the spectra. The decomposition conditions, measuring devices, and measurement conditions used for this measurement are shown below.
Degradation conditions: decomposition of the product with 10 wt % bisulfate (D₂SO₄) in heavy water (D₂O)
Measurement equipment: INOVA300 (Agilent Technologies)

Tables 1 show RHO types of Zn(BzIm)_{2-z}(4-MeIm)_{z} determined from ¹H-NMR spectra of the products of the Examples and Comparative Examples.

TABLE 1
Zn(Bzlm of RHO type of Examples and Comparative Examples)_{2-z}(4-Melm)_{z}

| | 4-Melm | Heating | Crystal | 4-Melm | |
|---|---|---|---|---|---|
| | charge | temperature | structure of the | content | |
| | (mol %) | (° C.) | product | (mol %) | Product distribution |
| Comparative | 0.0 | 80 | RHO Types | 0 | Zn(Bzlm)₂ |
| Example 1-1 | | | | | |
| Example 1-2 | 12.5 | 80 | RHO Types | 12 | Zn(Bzlm)_{1.76}(4-Melm)_{0.24} |
| Example 1-3 | 25.0 | 80 | RHO Types | 23 | Zn(Bzlm)_{1.54}(4-Melm)_{0.46} |
| Examples 1-4 | 50.0 | 80 | RHO Types | 48 | Zn(Bzlm)_{1.04}(4-Melm)_{0.96} |
| Comparative | 75.0 | 80 | ACO Types | — | — |
| Example 1-5 | | | | | |
| Comparative | 100.0 | 80 | ACO Types | — | — |
| Example 1-6 | | | | | |
| Comparative | 0.0 | 100 | Layered + RHO | — | — |
| Example 2-1 | | | type | | |
| Example 2-2 | 12.5 | 100 | RHO Types | 11 | Zn(Bzlm)_{1.78}(4-Melm)_{0.22} |
| Example 2-3 | 25.0 | 100 | RHO Types | 26 | Zn(Bzlm)_{1.48}(4-Melm)_{0.52} |
| Example 2-4 | 50.0 | 100 | RHO Types | 53 | Zn(Bzlm)_{0.94}(4-Melm)_{1.06} |
| Comparative | 75.0 | 100 | ACO Types | — | — |
| Example 2-5 | | | | | |
| Comparative | 100.0 | 100 | ACO Types | — | — |
| Example 2-6 | | | | | |
| Comparative | 0.0 | 130 | Layered | — | — |
| Example 3-1 | | | | | |
| Comparative | 12.5 | 130 | Layered | — | — |
| Example 3-2 | | | | | |
| Comparative | 25.0 | 130 | Layered + RHO | — | — |
| Example 3-3 | | | type | | |
| Example 3-4 | 50.0 | 130 | RHO Types | 52 | Zn(Bzlm)_{0.96}(4-Melm)_{1.04} |
| Comparative | 75.0 | 130 | ACO Types | — | — |
| Example 3-5 | | | | | |
| Comparative | 100.0 | 130 | ACO Types | — | — |
| Example 3-6 | | | | | |

From the results of the X-ray diffractogram, it was confirmed that the product confirmed to be RHO type contained 4-MeIm from the results of 1H-NMR. In Examples 1-2 to 1-4, 2-2 to 2-4, and 3-4, it is considered that an RHO type Zn(BzIm)_{2-z}(4-MeIm)_{z} in which a part of BzIm of the RHO type Zn(BzIm)₂ is substituted with 4-MeIm is obtained.

### 3. N₂ Adsorption Isotherms: Evaluating the Pore Capacity of MOF

For the products of the Examples and Comparative Examples, N₂ adsorption isotherms were measured after pretreatment, respectively. We also compared the N₂ sorption at 50% N₂. The pretreatment equipment, pretreatment conditions, measurement equipment, and measurement conditions used for this measurement are shown below.
Pretreatment equipment: BELPREPvacII (Microtrac Bell Co., Ltd.)
Pretreatment: Vacuum <10⁻² Pa, heated at 160° C. for 6 hours
Measuring device: BELSORPmax (Microtrac Bell Co., Ltd.)
Measurement: Temperature 77K, N₂ adsorption at N₂ relative pressure 0% to 99%.

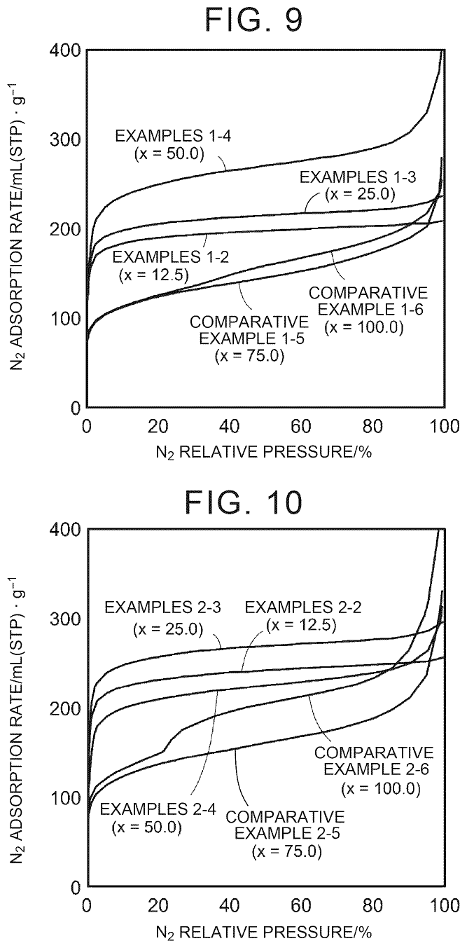

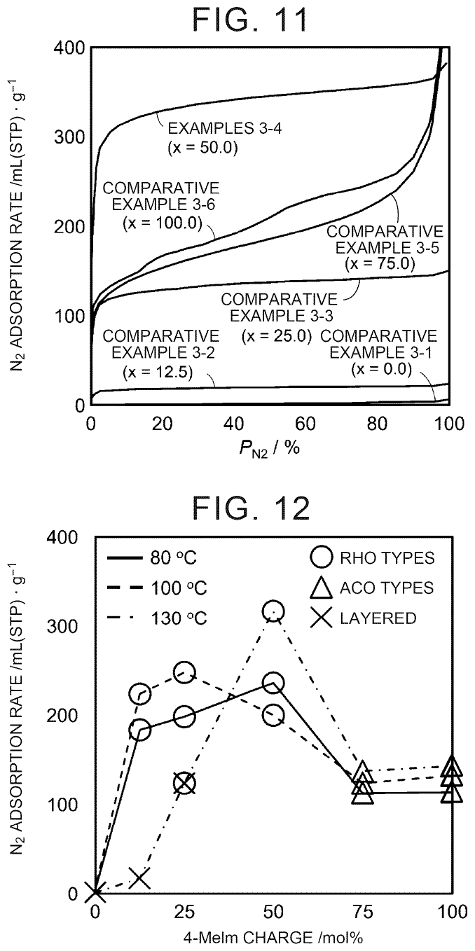

FIG. 9 shows N₂ adsorption-desorption isotherms of the products of Comparative Examples 1-5 and 1-6 and Examples 1-2 to 1-4, FIG. 10 shows N₂ adsorption-desorption isotherms of the products of Comparative Examples 2-5 and 2-6 and Examples 2-2 to 2-4, and FIG. 11 shows N₂ adsorption-desorption isotherms of the products of Comparative Examples 3-1 to 3-3, 3-5 and 3-6 and Example 3-4. In Comparative Examples 1-1 and 2-1, it was difficult to obtain the N₂ adsorption isotherm because the time required for the N₂ adsorption measurement was very long, and the liquid-nitrogen required to maintain the measurement temperature (77K) was evaporated. FIG. 12 shows the crystal structure of the product produced at each heating temperature in the relation between the charge amount (mol %) (horizontal axis) of 4-MeIm and N₂ relative pressure of 50%: N₂ adsorption amount (mL(STP)·g⁻¹) (vertical axis). In addition, Table 2 summarizes the synthesis conditions of the examples and comparative examples (4-MeIm charge amount, heating temperature), the crystal structure of the product and the content of 4-MeIm, and the N₂ adsorption amount.

TABLE 2
Synthetic conditions of Examples and Comparative Examples, crystalline
structure of the product and content of 4-Melm, and N₂ adsorption

| | 4-Melm | Heating | Crystal | 4-Melm | N₂ adsorption |
|---|---|---|---|---|---|
| | charge | temperature | structure of the | content | rate |
| | (mol %) | (° C.) | product | (mol %) | (mL(STP) · g⁻¹) |
| Comparative | 0.0 | 80 | RHO Types | — | (Not |
| Example 1-1 | | | | | measurable) |
| Example 1-2 | 12.5 | 80 | RHO Types | 12 | 183.38 |
| Example 1-3 | 25.0 | 80 | RHO Types | 23 | 198.18 |
| Example 1-4 | 50.0 | 80 | RHO Types | 48 | 236.16 |
| Comparative | 75.0 | 80 | ACO Types | — | 112.63 |
| Example 1-5 | | | | | |
| Comparative | 100.0 | 80 | ACO Types | — | 113.60 |
| Example 1-6 | | | | | |
| Comparative | 0.0 | 100 | Layered + RHO | — | (Not |
| Example 2-1 | | | type | | measurable) |
| Example 2-2 | 12.5 | 100 | RHO Types | 11 | 223.48 |
| Example 2-3 | 25.0 | 100 | RHO Types | 26 | 247.88 |
| Example 2-4 | 50.0 | 100 | RHO Types | 53 | 199.62 |
| Comparative | 75.0 | 100 | ACO Types | — | 123.59 |
| Example 2-5 | | | | | |
| Comparative | 100.0 | 100 | ACO Types | — | 132.07 |
| Example 2-6 | | | | | |
| Comparative | 0.0 | 130 | Layered | — | 0.932 |
| Example 3-1 | | | | | |
| Comparative | 12.5 | 130 | Layered | — | 17.392 |
| Example 3-2 | | | | | |
| Comparative | 25.0 | 130 | Layered + RHO | — | 123.44 |
| Example 3-3 | | | type | | |
| Example 3-4 | 50.0 | 130 | RHO Types | 52 | 316.72 |
| Comparative | 75.0 | 130 | ACO Types | — | 137.15 |
| Example 3-5 | | | | | |
| Comparative | 100.0 | 130 | ACO Types | — | 142.60 |
| Example 3-6 | | | | | |

The products of Comparative Examples 1-1 and 2-1 took a very long time to measure the adsorption of N₂ and failed to obtain the adsorption isotherm of N₂ because the pore windows of RHO type Zn(BzIm)₂ were narrow and the diffusion-into the pores of N₂ was very slow.

On the other hand, in the products (FIG. 12, ∘) of Examples 1-2 to 1-4, 2-2 to 2-4, and 3-4, in which Zn(BzIm)_{2-z}(4-MeIm)_{z} was obtained in which the RHO type crystalline structure is the same and a part of BzIm was replaced with 4-MeIm, an N₂ adsorption isotherm was obtained. It can be inferred that this is because the pore windows are enlarged by replacing a part of BzIm with 4-MeIm, and the diffusibility of N₂ is improved.

Incidentally, in Comparative Example 3-3 (overlap of ox in FIG. 12), in addition to RHO type Zn(BzIm)_{2-z}(4-MeIm)_{z}, layered Zn(BzIm)_{2-z}(4-MeIm)_{z} without pores that can adsorb gas was generated, and the amount of N₂ adsorbed was decreased by that amount.

In Comparative Examples 1-5 to 1-6, 2-5 to 2-6, and 3-5 to 3-6 (A of FIG. 12), ACO type Zn(BzIm)_{2-z}(4-MeIm)_{z} was formed, and the N₂ adsorption quantity was smaller than that of RHO type.

This makes it easier to obtain a product of RHO type through synthesis by replacing a part of BzIm of the RHO type Zn(BzIm)₂ with 4-MeIm. It was confirmed that a part of BzIm was replaced with 44-MeIm to enlarge the pore windows and to improve the gas-adsorption quantity and diffusibility.

The present disclosure is not limited to the above-described embodiments, and includes various modifications. For example, the above-described embodiments have been described in detail for the purpose of illustrating the present disclosure in an easy-to-understand manner, and are not necessarily limited to those having all the described configurations. Further, it is possible to add, delete, and/or replace a part of the configuration of each embodiment with another configuration.

What is claimed is:

1. A metal organic framework having RHO topology, comprising zinc (Zn) as metal and benzimidazole (BzIm) and 4-methylimidazole (4-MeIm) as ligands.

2. The metal organic framework according to claim 1, wherein a molar ratio (4-MeIm/(BzIm+4-MeIm)) of 4-MeIm to a total of BzIm and 4-MeIm is in a range of 0.11 to 0.53.

3. A gas absorbing and desorbing material comprising an absorbing and desorbing material, wherein:
the absorbing and desorbing material contains the metal organic framework according to claim 1; and
the metal organic framework contains the RHO topology in an amount of 90 mol % or more based on a total substance amount of the metal organic framework.

4. A method of producing the metal organic framework according to claim 1, the method comprising:
a mechanochemical reaction step of subjecting a zinc compound, BzIm, and 4-MeIm to a mechanochemical reaction in presence of a solvent; and
a heating step after the mechanochemical reaction step, wherein a relationship between a charge amount of 4-MeIm and a heating temperature is adjusted to be within a range of a quadrilateral having (x, y)=(12.5, 80), (50, 80), (50, 130), and (12.5, 100) as vertices in an x-y graph indicating the relationship between the charge amount of 4-MeIm (x mol %) and the heating temperature (y ° C.).

5. The method according to claim 4, wherein the solvent is N,N-diethylformamide (DEF) and the zinc compound is zinc oxide (ZnO).
